(19) United States
(12) Patent Application Publication
(10) Pub. No.: US 2026/0036880 A1
(43) Pub. Date: Feb. 5, 2026

(54) SURVEILLANCE DEVICE

(71) Applicant: PEGATRON CORPORATION, Taipei City (TW)

(72) Inventors: AN-CHENG CHEN, Taipei City (TW); CHI-MENG CHAN, Taipei City (TW); WEN-CHUANG YU, Taipei City (TW)

(21) Appl. No.: 19/227,962

(22) Filed: Jun. 4, 2025

(30) Foreign Application Priority Data
Aug. 2, 2024 (TW) 113208349

(51) Int. Cl. G03B 15/03; G03B 17/02; H05B 47/11

(52) U.S. Cl. CPC G03B 15/03; G03B 17/02; H05B 47/11

(57) ABSTRACT

A surveillance device includes a main body, a camera module, a plurality of sets of infrared light-emitting units, a photosensor, and a controller. The main body comprises four sidewalls and a top surface. The camera module includes four cameras, each disposed on a respective one of the four sidewalls. The plurality of sets of infrared light-emitting units are configured to provide infrared light. A first set of infrared light-emitting units is disposed on the top surface of the main body, and a second set of infrared light-emitting units is disposed on the four sidewalls of the main body and positioned adjacent to the four cameras. The photosensor is disposed on the main body and configured to detect ambient light. The controller is configured to turn on or off the plurality of sets of infrared light-emitting units based on the detected ambient light to provide supplementary illumination to the environment.

### CROSS-REFERENCE TO RELATED APPLICATION

This application claims the priority benefit of Taiwan application serial No. 113208349, filed on Aug. 2, 2024. The entirety of the above-mentioned patent application is hereby incorporated by reference herein and made a part of this specification.

### BACKGROUND

### 1. Technical Field

The present disclosure relates to a surveillance device.

### 2. Description of the Related Art

As people increasing emphasis on the quality and safety of their living environments, surveillance devices are frequently used to reduce security blind spots in various locations. Conventional surveillance devices are equipped with video recording (image capturing) functions. Currently, there are wide-angle panoramic surveillance devices that utilize a single camera module in combination with a rotatable base to capture images from different areas. However, the time delay caused by the rotation of the camera module may result in blind spots during surveillance. Therefore, surveillance devices comprising multiple camera modules have also been developed, such as 360-degree fisheye security camera, which utilize multiple camera modules to capture images from different areas and either directly present multiple views or stitch them into a single image through image processing.

The conventional surveillance devices employing multiple camera modules are typically dome-shaped or arc-shaped similar to a hemisphere and are top-mounted at elevated positions. The multiple cameras are tilted downward and outward to capture images from various angles. However, slight blind spots may still exist between the captured images due to the aforementioned structure. In addition, under conditions of insufficient ambient light, the edges of images captured by the camera modules are prone to blurring, making it difficult to stitch the images into a complete scene, thereby still resulting in visual blind spots.

### SUMMARY

In view of the issue above, it is a primary object of the present disclosure to provide a surveillance device comprising a main body, a camera module, a plurality of sets of infrared light-emitting units, a photosensor, and a controller. Through the structure of the main body and the arrangement of the plurality of sets of infrared light-emitting units, the camera module, the photosensor, and the controller, the device is designed to address the issue of visual blind spots that are commonly found in conventional surveillance device.

To achieve the above objective, the present disclosure provides a surveillance device, which comprises a main body, a camera module, a plurality of sets of infrared light-emitting units, a photosensor and a controller. The main body comprises four sidewalls and a top surface, the top surface is connected to the four sidewalls. The camera module comprises four cameras respectively disposed on the four sidewalls. The camera module is configured to monitor an environment. The plurality of sets of infrared light-emitting units are configured to provide infrared light. The plurality of sets of infrared light-emitting units comprises a first set of infrared light-emitting units and a second set of infrared light-emitting units. The first set of infrared light-emitting units is disposed on the top surface of the main body, and the second set of infrared light-emitting units is disposed on the four sidewalls of the main body and adjacent to the four cameras. The photosensor is disposed on the main body. The photosensor is configured to detect ambient light. The controller is electrically connected to the camera module, the plurality of sets of infrared light-emitting units, and the photosensor. The controller is configured to turn on or off the plurality of sets of infrared light-emitting units based on the ambient light to provide supplementary illumination to the environment.

According to an embodiment of the present disclosure, the photosensor is disposed on the top surface of the main body.

According to an embodiment of the present disclosure, the main body further comprises a plurality of cover plates respectively disposed on the top surface and the four sidewalls, configured to cover the plurality of sets of infrared light-emitting units.

According to an embodiment of the present disclosure, the cover plates located on the four sidewalls further comprise an opening configured to expose the four cameras.

According to an embodiment of the present disclosure, an outer surface of the cover plate located on the top surface further comprises an infrared light-transmissive ink layer. The infrared light emitted by the plurality of sets of infrared light-emitting units passes through the infrared light-transmissive ink layer to provide supplementary illumination to the environment.

According to an embodiment of the present disclosure, the outer surfaces of the cover plates located on the four sidewalls respectively comprise an infrared light-transmissive ink layer. The infrared light emitted by the plurality of sets of infrared light-emitting units passes through the infrared light-transmissive ink layer to provide supplementary illumination to the environment.

According to an embodiment of the present disclosure, the surveillance device further comprises a circuit board, and the controller is disposed on the circuit board. The main body comprises a first housing and a second housing connected to each other. The camera module, the infrared light-emitting units, and the photosensor are disposed on the first housing. The circuit board is disposed on the second housing.

According to an embodiment of the present disclosure, the first housing and the second housing form a square prism.

According to an embodiment of the present disclosure, the four cameras are disposed on four sidewalls of the square prism to obtain an eastward image, a westward image, a southward image, and a northward image.

According to an embodiment of the present disclosure, the controller performs image stitching on the eastward image, the westward image, the southward image, and the northward image to generate an omnidirectional image.

In continuation of the above, according to the surveillance device of the present disclosure, the device comprises a main body, a camera module, a plurality of sets of infrared light-emitting units, a photosensor, and a controller. The photosensor is configured to detect ambient light. The controller is electrically connected to the camera module, the infrared light-emitting units, and the photosensor. The controller is operable to turn the plurality of sets of infrared light-emitting units on or off based on the detected ambient light, thereby providing supplementary illumination to the environment. The camera module comprises four cameras, respectively disposed on four sidewalls of the main body, such that image frames in the east, west, south, and north directions can be captured, facilitating omnidirectional image acquisition and subsequent image stitching. Furthermore, the infrared light-emitting units are disposed around the outer peripheries of the cameras, thereby achieving full-directional illumination and preventing the occurrence of visual blind spots at the edges of the captured images due to insufficient lighting.

### BRIEF DESCRIPTION OF THE DRAWINGS

FIG. 1 is a schematic view of a surveillance device according to an embodiment of the present disclosure;

FIG. 2 is a partially exploded view of the surveillance device shown in FIG. 1;

FIG. 3 is a top view of the surveillance device shown in FIG. 1; and

FIG. 4 is a schematic view showing the internal structure of the surveillance device shown in FIG. 1.

### DETAILED DESCRIPTION OF THE EMBODIMENTS

In order to make the structure, characteristics, and effectiveness of the disclosure further understood and recognized, a detailed description of the disclosure is provided as follows, along with embodiments and accompanying figures.

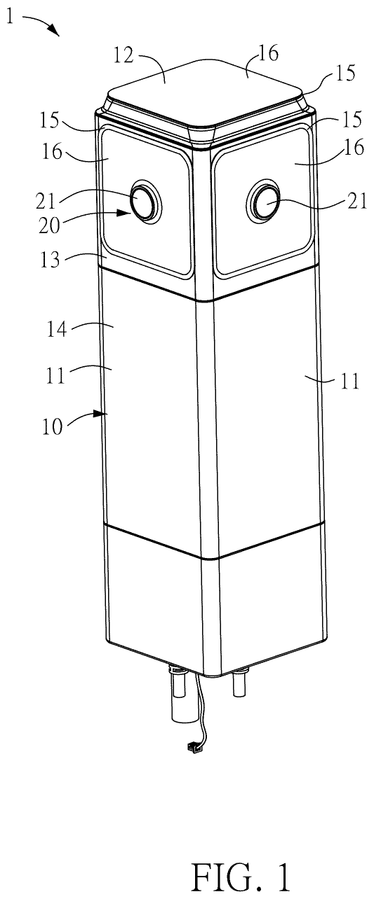

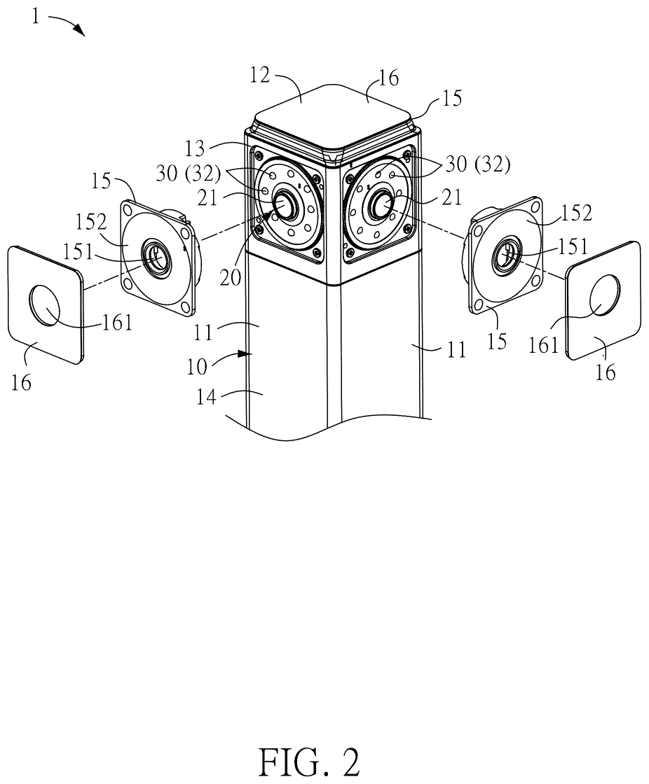

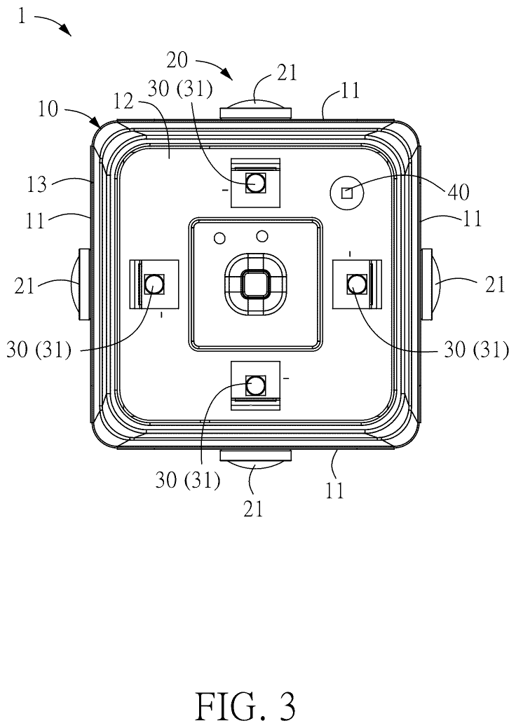

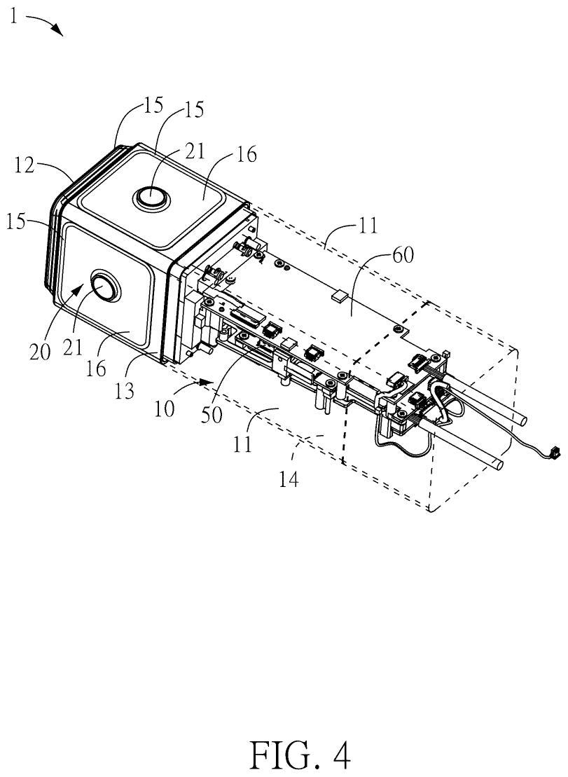

FIG. 1 is a schematic view of a surveillance device according to an embodiment of the present disclosure; FIG. 2 is a partially exploded view of the surveillance device shown in FIG. 1; FIG. 3 is a top view of the surveillance device shown in FIG. 1; and FIG. 4 is a schematic view showing the internal structure of the surveillance device shown in FIG. 1. Refer to FIG. 1, FIG. 2, FIG. 3 and FIG. 4. In this embodiment, the surveillance device 1 comprises a main body 10, a camera module 20, a plurality of infrared light-emitting units 30, a photosensor 40, and a controller 50 (as shown in FIG. 4). The controller 50 is electrically connected to the camera module 20, the plurality of infrared light-emitting units 30, and the photosensor 40. The main body 10 comprises four sidewalls 11 and a top surface 12. The top surface 12 is connected to the four sidewalls 11 to form a square prism. The camera module 20 is configured to monitor an environment and capture images of the environment at different time points. In this embodiment, the camera module 20 comprises four cameras 21, each of which is disposed on one of the four sidewalls 11, as shown in FIG. 3. In other words, each sidewall 11 is provided with one camera 21, thereby capturing omnidirectional image frames in the east, west, south, and north directions. This arrangement facilitates subsequent image stitching and helps to avoid the occurrence of visual blind spots. Specifically, the four cameras 21 are disposed on the four sidewalls 11 of the square prism to respectively capture an eastward image, a westward image, a southward image, and a northward image, which are then transmitted to the controller 50. The controller 50 may subsequently perform image stitching on the eastward image, the westward image, the southward image, and the northward image to generate an omnidirectional image, thereby preventing the occurrence of visual blind spots.

As shown in FIG. 2 and FIG. 3, the surveillance device 1 of the present embodiment comprises a first set of infrared light-emitting units 31 and a second set of infrared light-emitting units 32. The first set of infrared light-emitting units 31 is disposed on the top surface 12 of the main body 10, as illustrated in FIG. 3. The second set of infrared light-emitting units 32 is disposed on the sidewalls 11 of the main body 10, as shown in FIG. 2. In other words, in this embodiment, the plurality of infrared light-emitting units 30 disposed on the top surface 12 are referred to as the first set of infrared light-emitting units 31, and the plurality of infrared light-emitting units 30 disposed on the sidewalls 11 are referred to as the second set of infrared light-emitting units 32. As shown in FIG. 2, each of the infrared light-emitting units 30 of the second set of infrared light-emitting units 32 is disposed on one of the four sidewalls 11 and is located adjacent to the corresponding one of the four cameras 21. That is, a plurality of infrared light-emitting units 30 are respectively arranged around the outer periphery of each camera 21. Preferably, the infrared light-emitting units 30 are disposed in a surrounding configuration around the outer periphery of each camera 21. For example, eight infrared light-emitting units 30 are arranged in a circular manner around the camera 21 with the camera 21 as the center. The infrared light-emitting units 30 are configured to emit infrared light, which may be, for example, infrared light-emitting diodes (IR LEDs). With the arrangement of the infrared light-emitting units 30, supplementary illumination can be provided to the environment when ambient light is insufficient.

As shown in FIG. 3, the photosensor 40 of this embodiment is disposed on the main body 10. Preferably, the photosensor 40 is disposed on the top surface 12 of the main body 10. The photosensor 40 is configured to detect ambient light and is electrically connected to the controller 50. In this embodiment, the surveillance device 1 preferably further comprises a circuit board 60, and the controller 50 is disposed on the circuit board 60, as shown in FIG. 4. In this embodiment, the camera module 20, the infrared light-emitting units 30, and the photosensor 40 are electrically connected to the controller 50 via the circuit board 60. For example, a flexible circuit board may be used to connect the camera module 20, the infrared light-emitting units 30, and the photosensor 40 to the circuit board 60, thereby establishing electrical connection with the controller 50 disposed on the circuit board 60.

The photosensor 40 is a light-sensing element used to detect ambient light and may be, but is not limited to, an ambient light sensor (ALS). The photosensor 40 is capable of detecting the amount of ambient light to obtain a light-sensing parameter, which is then transmitted to the controller 50. The controller 50 may turn the infrared light-emitting units 30 on or off based on the ambient light in order to provide supplementary illumination to the environment. For example, when the light-sensing parameter is less than or equal to a predetermined value, the controller 50 determines that the ambient light is insufficient and activates the infrared light-emitting units 30 to emit infrared light, thereby achieving supplementary illumination. As a result, even in low-light conditions, the infrared light-emitting units 30 can provide supplementary light to capture clear night vision images. Conversely, when the light-sensing parameter exceeds the predetermined value, the controller 50 determines that the ambient light is sufficient and deactivates the infrared light-emitting units 30.

In addition, because the infrared light-emitting units 30 of the second set of infrared light-emitting units 32 are disposed around the outer periphery of the four cameras 21, an omnidirectional supplementary illumination effect can be achieved, which helps prevent visual blind spots at the edges of the image due to insufficient lighting. Furthermore, the infrared light-emitting units 30 of the first set of infrared light-emitting units 31 are disposed on the top surface 12 of the main body 10, which further prevents the corners of the image from becoming shadowed or blurred due to inadequate lighting.

Preferably, the main body 10 of this embodiment comprises a first housing 13 and a second housing 14 that are connected to each other. The camera module 20, the infrared light-emitting units 30, and the photosensor 40 are disposed on the first housing 13, while the controller 50 and the circuit board 60 are disposed in the second housing 14, as shown in FIG. 4. Specifically, both the first housing 13 and the second housing 14 are square prisms, allowing them to collectively form a square prism. The volume of the second housing 14 is greater than that of the first housing 13. The cameras 21 are respectively disposed on the four sidewalls 11 of the square prism; in this embodiment, they are disposed on the four sidewalls 11 of the first housing 13. The infrared light-emitting units 30 are respectively disposed on the four sidewalls 11 and the top surface 12 of the first housing 13, and the photosensor 40 is disposed on the top surface 12 of the first housing 13. The controller 50 and the circuit board 60 are disposed within the second housing 14. When installing the surveillance device 1 of the present embodiment, the second housing 14 may be mounted on a wall or ceiling, so that the first housing 13 and the top surface 12 face the surrounding environment. Because the photosensor 40 is disposed on the top surface 12 of the first housing 13 and faces the environment, it can effectively detect ambient light and obtain more accurate light-sensing parameters.

Preferably, the body 10 of this embodiment further comprises a plurality of cover plates 15, which are respectively disposed on the four side walls 11 and the top surface 12. The plurality of cover plates 15 are used to cover the infrared light-emitting units 30. It should be noted that in FIG. 3, the cover plate 15 located on the top surface 12 is removed to reveal the structures such as the infrared light-emitting units 30 and the photosensor 40 positioned on the top surface 12. In the present embodiment, the cover plates 15 on the side walls 11 further comprise an opening 151 and a light-transmitting portion 152. The opening 151 corresponds to the camera 21 and is used to expose the camera 21. That is, the camera 21 of the camera module 20 can pass through the opening 151. The cover plate 15 covers the infrared light-emitting unit 30, and the infrared light emitted from the infrared light-emitting unit 30 can still pass through the light-transmitting portion 152 of the cover plate 15.

Furthermore, the body 10 of this embodiment further comprises a plurality of infrared light-transmissive ink layers 16, which are located on the outer surfaces of the cover plates 15 on the top surface 12 and the side walls 11. In other words, the infrared light-transmissive ink layers 16 are disposed on the outer surfaces of the cover plates 15. In one embodiment, the infrared light-transmissive ink can be directly coated on the outer surface of the cover plate 15 to form the infrared light-transmissive ink layer 16. In another embodiment, the infrared light-transmissive ink can be coated on a film or a plate first, and then the film or plate with the coated ink can be disposed on the outer surface of the cover plate 15 to form the infrared light-transmissive ink layer 16. The infrared light-transmissive ink layer 16 located on the side wall 11 also includes an opening 161, which corresponds to the position of the camera 21, so that the camera 21 can simultaneously pass through both the openings 151 and 161.

The infrared light emitted by the infrared light-emitting unit 30 can still pass through the cover plate 15 and the infrared light-transmissive ink layer 16, and therefore the function of providing supplemental illumination for the environment as above described can still be achieved. At the same time, the infrared light-transmissive ink layer 16 can visually conceal the structure of the infrared light-emitting unit 30, thereby providing a consistent and aesthetically pleasing appearance for the surveillance device 1. In this embodiment, both the infrared light-transmissive ink layer 16 and the cover plate 15 are quadrilateral in shape. In other embodiments, the shape of the infrared light-transmissive ink layer 16 may correspond only to the light-transmitting portion 152 of the cover plate 15. That is, the infrared light-transmissive ink layer 16 may also be annular in shape, the present disclosure is not limited thereto.

Because the camera 21 of this embodiment is not disposed on the top surface 12, the infrared light-transmissive ink layer 16 on the top surface 12 may not include the opening 161. In other embodiments, the camera 21 may instead be disposed on the top surface 12, and in such cases, the infrared light-transmissive ink layer 16 on the top surface 12 may include the opening 161 accordingly. The present disclosure is not limited in this regard. It should also be noted that in FIG. 3, the infrared light-transmissive ink layer 16 on the top surface 12 of the body 10 is also removed in order to reveal the infrared light-emitting unit 30 and the photosensor 40 located on the top surface 12.

In summary, the surveillance device disclosed herein comprises a body, a camera module, a plurality of sets of infrared light-emitting units, a photosensor, and a controller. The photosensor is configured to detect ambient light. The controller is electrically connected to the camera module, the plurality of sets of infrared light-emitting units, and the photosensor. The controller is operable to turn the plurality of sets of infrared light-emitting units on or off based on the detected ambient light, thereby providing supplementary illumination to the environment. The camera module comprises four cameras, respectively disposed on four sidewalls of the main body, such that image frames in the east, west, south, and north directions can be captured, facilitating omnidirectional image acquisition and subsequent image stitching. Furthermore, the infrared light-emitting units are disposed around the outer peripheries of the cameras, thereby achieving full-directional illumination and preventing the occurrence of visual blind spots at the edges of the captured images due to insufficient lighting.

Although the present disclosure has been explained in relation to its preferred embodiments, it is to be understood that many other possible modifications and variations can be made without departing from the spirit and scope of the disclosure as hereinafter claimed.

What is claimed is:

1. A surveillance device, comprising:
a main body, comprising four sidewalls and a top surface, the top surface being connected to the four sidewalls;
a camera module, comprising four cameras respectively disposed on the four sidewalls, the camera module being configured to monitor an environment;
a plurality of sets of infrared light-emitting units configured to provide infrared light, the plurality of sets of infrared light-emitting units comprising a first set of infrared light-emitting units and a second set of infrared light-emitting units, the first set of infrared light-emitting units being disposed on the top surface of the main body, and the second set of infrared light-emitting units being disposed on the four sidewalls of the main body and adjacent to the four cameras;
a photosensor disposed on the main body, the photosensor being configured to detect ambient light; and
a controller electrically connected to the camera module, the plurality of sets of infrared light-emitting units, and the photosensor, the controller being configured to turn on or off the plurality of sets of infrared light-emitting units based on the ambient light to provide supplementary illumination to the environment.

2. The surveillance device according to claim 1, wherein the photosensor is disposed on the top surface of the main body.

3. The surveillance device according to claim 1, further comprising a plurality of cover plates respectively located on the top surface and the four sidewalls, configured to cover the plurality of sets of infrared light-emitting units.

4. The surveillance device according to claim 3, wherein the cover plates disposed on the four sidewalls further comprise an opening configured to expose the four cameras.

5. The surveillance device according to claim 3, wherein an outer surface of the cover plate located on the top surface further comprises an infrared light-transmissive ink layer, and the infrared light emitted by the plurality of sets of infrared light-emitting units passes through the infrared light-transmissive ink layer to provide supplementary illumination to the environment.

6. The surveillance device according to claim 5, wherein the outer surfaces of the cover plates located on the four sidewalls respectively comprise an infrared light-transmissive ink layer, and the infrared light emitted by the plurality of sets of infrared light-emitting units passes through the infrared light-transmissive ink layer to provide supplementary illumination to the environment.

7. The surveillance device according to claim 1, further comprising a circuit board, wherein the circuit board is disposed on the controller, wherein the main body comprises a first housing and a second housing connected to each other, and the camera module, the plurality of sets of infrared light-emitting units, and the photosensor are disposed on the first housing, and the circuit board is disposed on the second housing.

8. The surveillance device according to claim 7, wherein the first housing and the second housing form a square prism.

9. The surveillance device according to claim 8, wherein the four cameras are disposed on four sidewalls of the square prism to obtain an eastward image, a westward image, a southward image, and a northward image.

10. The surveillance device according to claim 9, wherein the controller performs image stitching on the eastward image, the westward image, the southward image, and the northward image to generate an omnidirectional image.
